(19) United States
(12) Patent Application Publication
(10) Pub. No.: US 2024/0180120 A1
(43) Pub. Date: Jun. 6, 2024

(54) TUBULAR CONNECTING ELEMENT BETWEEN CAGES FOR HOUSEHOLD PETS

(71) Applicant: FERPLAST S.P.A., Vicenza (IT)

(72) Inventor: Nicola VACCARI, Vicenza (IT)

(21) Appl. No.: 18/556,205

(22) PCT Filed: Mar. 22, 2022
(86) PCT No.: PCT/IB2022/052594

§ 371 Date: Oct. 19, 2023

(30) Foreign Application Priority Data
May 13, 2021 (IT) 102021000012383

(51) Int. Cl. A01K 1/035

(52) U.S. Cl. CPC A01K 1/035

(57) ABSTRACT

Tubular connecting element adapted to be joined to further consecutive tubular connecting elements to form a connection between cages and enclosed spaces or the like that are traversable by household pets, comprising a tubular body that, at the two ends thereof, has a spherical cap portion that forms a first half of a spherical joint and a spherical cap portion that forms a second half of a spherical joint placed at the opposite end of the tubular element.

### FIELD OF APPLICATION

The present invention relates to a tubular connecting element between cages for household pets, in particular rodents, which can be used together with other tubular connecting elements for the creation of artificial habitats, i.e. for the creation of customizable, modular paths of various lengths, which can be traversed by the contained animals.

More in particular, said tubular connecting element is suitable for being joined with further consecutive tubular connecting elements to form a connection between cages and enclosed spaces or the like, thereby realising an autonomous transfer means of the rodents between the various environments, which can pass, for example, from a cage to an enclosed area set up externally and vice versa.

The tubular connecting element according to the invention comprises a tubular body which, at the two ends thereof, has a spherical cap portion forming a first half of a spherical joint and a spherical cap portion forming a second half of a spherical joint placed at the opposite end of the tubular element.

The present invention is advantageously applied in the field of accessories for household pets, and in more detail in the field of artificial habitats comprising customizable paths for animals in particular rodents, such as rabbits, guinea pigs or the like.

### PRIOR ART

It is known that rodents, such as rabbits, hamsters or guinea pigs or the like, particularly love to dig, create hiding places and move through burrows and tunnels.

This behaviour is the focus of many artificial habitat builders who work to develop a component based on the use of modular sleeves or tubes and their joints, which can be connected to each other to create customizable, modular paths of various lengths, and which can be connected to their respective cages by connecting them to enclosures or other, being able to obtain routes that start and end in the same cage, or that connect different cages, or that create paths between the interior of the cage and the exterior, for example to reach a grassy fenced area on which to nibble

Over time, many of the problems related to this type of item have been solved by the various manufacturers using shapes, diameters, accessories, connections which are increasingly high-performance connections, in order to offer the greatest possible opportunities to the animal and its owner.

In fact, modular tubular element designs have been developed in different materials, such as wood, metal, cardboard, but more commonly in plastic material, in the latter case obtained for example by injection moulding, or blowing or extrusion.

In other cases, solutions have been developed involving the use of rigid or flexible tubes, in other cases ready and pre-assembled and in other cases consisting of two half parts that can be hooked together.

Tubular elements of different diameters have also been provided, for example from about 6 cm for small rodents such as hamsters or mice to about 10 cm for medium rodents such as ferrets, up to about 20 cm for rabbits, chinchilla, guinea pigs.

Connecting elements have also been developed, for the aforesaid tubular elements, having different shapes, such as straight and short, or straight and long, or with parts curved 90°, curved 180°, i.e., in a “U” shape, straight and extendable, or in a “T” shape.

According to further embodiments, joined tubular elements have been proposed outside the cage with connecting wells having different forms of ventilation, such as grilles, holes or with different connecting systems to the cages and each other, so as to be able to customize the tunnel as much as possible.

Some solutions have been used for internal use, thus with materials that are not very resistant to the weather but with more creative aesthetic effects, others for external use, and in the latter case also comprising anti-bite elements against predators.

All the tubular elements known in the art have many components, connections and accessories that allow the connection therebetween and with the cages, which, being multiple and each different from the others both in terms of functionality and size, have the common disadvantage of making the production steps and also those of assembly complex and expensive, both in terms of time and above all of management costs.

In fact, another drawback that derives from the multitude of components and accessories necessary for the use of the known tubular systems concerns the need for manufacturers to create a myriad of various components and accessories having different functions and sizes in large quantities, which must then be stored to make them always available to the public, with all the problems that also derive for retailers from the point of view of logistics and the encumbrance of the occupied spaces, especially if the tubular elements are made in a single piece.

Furthermore, the tubular elements used for rodents are often used externally, so in many situations they must be raised from the ground in order not to ruin the grass of a garden, further increasing the number of components used.

Finally, it must be considered that the larger diameter tubes, for example those for the passage of rabbits, are very bulky and, if made whole, have high transport volumes, leading to further high operating costs.

Document US 2008/0141947 A1 describes a device for adjusting the angle between two tubes used as a play area for household pets and comprises a first connecting unit connected to a first tube, a connecting body and a second connecting unit connected to a second tube and to the connecting body.

### DESCRIPTION OF THE INVENTION

The present invention aims to provide a tubular connecting element for household pets, in particular rodents, made by using modular components comprising connecting and articulating elements integrated in the same tubular elements, thus obtaining a condition capable of eliminating or at least reducing the drawbacks highlighted above with the traditional tubular transfer systems for animals.

The invention aims in particular to create a tubular element for the passage of rodents, made by joining at least two tubular half-parts whose ends are shaped like portions of spherical caps, with the possibility of forming spherical joints when two identical connecting elements are connected to each other.

Said portions of spherical caps form at one end of the tubular element a male connecting component and at the other end a female connecting component.

The two spherical cap ends of the tubular elements, when two identical connecting elements are connected to each other, make a spherical joint that allows the rotation of a semi-spherical component inside the other, said spherical joint allowing the rotation within a set solid angle between one tubular component and the other, according to the ratio between the diameter of the sphere and that of the tube.

All this is obtained by means of a system for connecting to modular and articulated tubular elements for household pets, the features of which are described in the main claim.

The dependent claims of the present solution outline advantageous embodiments of the invention.

The main advantages of this solution ultimately relate to the modularity and perfect integration between tubular elements provided with articulating elements that make their use extremely simple in cases where it is intended to let the animal independently exit to spaces outside the cage to which they are paired.

Another object of the invention is to simplify production operations since the tubular elements are modular but comprise the joining elements provided with an articulated joint that must not be made separately, with a consequent overall improvement from the point of view of logistics and from that of overall dimensions, since the modules that make up the tubular elements are all equal, comprise articulating joining ends and therefore are only to be made in a few main sizes.

Another advantage deriving from the solution in question is the possibility of limiting the management and storage difficulties of the components for the retailer, as it can have a single model of modular tubular element already complete with joining and articulating elements that are integrated therein.

### ILLUSTRATION OF THE DRAWINGS

Other features and advantages of the invention will become apparent from reading the following description of an embodiment of the invention provided by way of non-limiting example, with the aid of the figures illustrated in the appended tables of drawings, in which:

FIGS. 1 and 1a depict schematic and axonometric perspective views of a first embodiment example of the connecting elements according to the invention, seen respectively from above and from the side;

FIGS. 2, 2a, 2b and 2c illustrate detailed schematic views of all the components assembled and depicted from different points of view;

FIGS. 3 and 3a show schematic views of a pair of reciprocally joined tubular elements depicted respectively from the top and side of which the first is fixed and the second oriented in two different positions;

FIGS. 4 and 4a are schematic and perspective views of one of the tubular elements according to the invention depicted respectively exploded and assembled;

FIGS. 5 and 5a are perspective views of a first female connecting element applicable to a hole made on a cage, respectively assembled and exploded;

FIGS. 6 and 6a are perspective views of a second male connecting element applicable to a hole made on the same or another cage or on a fence, respectively assembled and exploded;

FIGS. 7 to 7d depict views of some complete and mutually joined tubular elements, depicted according to different angles;

FIGS. 8 to 8e show schematic and axonometric or other perspective views of a further embodiment of the tubular elements;

FIGS. 9 to 9c illustrate schematic views at various angles of a further embodiment in which the two female ends and/or the male end of the tubular element are made using adjacent portions of flexible hemispherical tabs.

### DESCRIPTION OF AN EMBODIMENT OF THE INVENTION

Referring to the appended figures, 10 generally indicates a possible artificial habitat for rodents, in particular rabbits, guinea pigs or the like, which includes some reciprocally joinable components, in order to create an ideal environment for the contained animals.

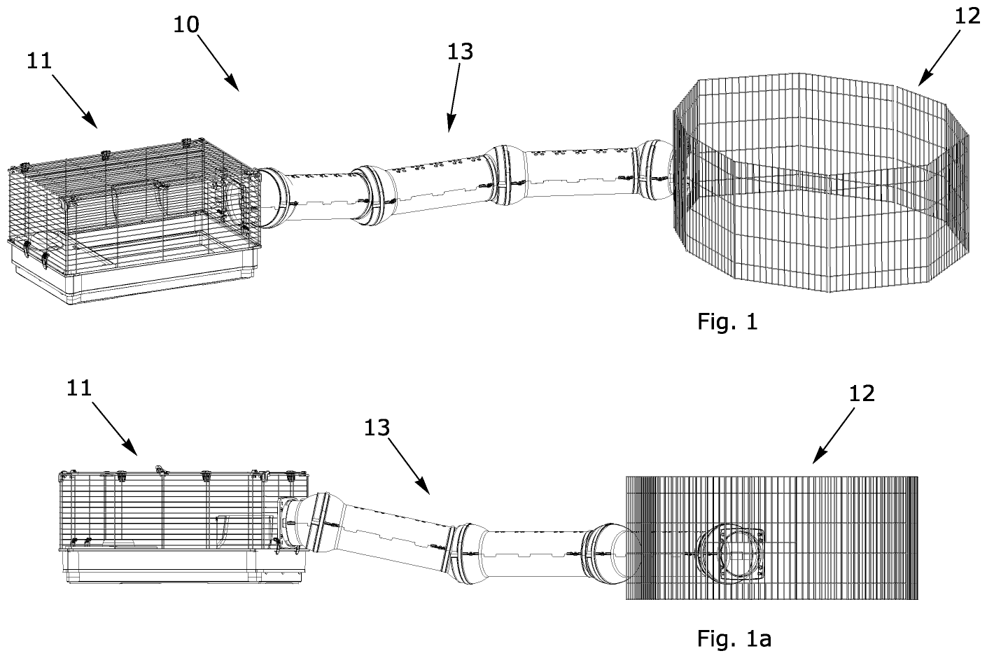

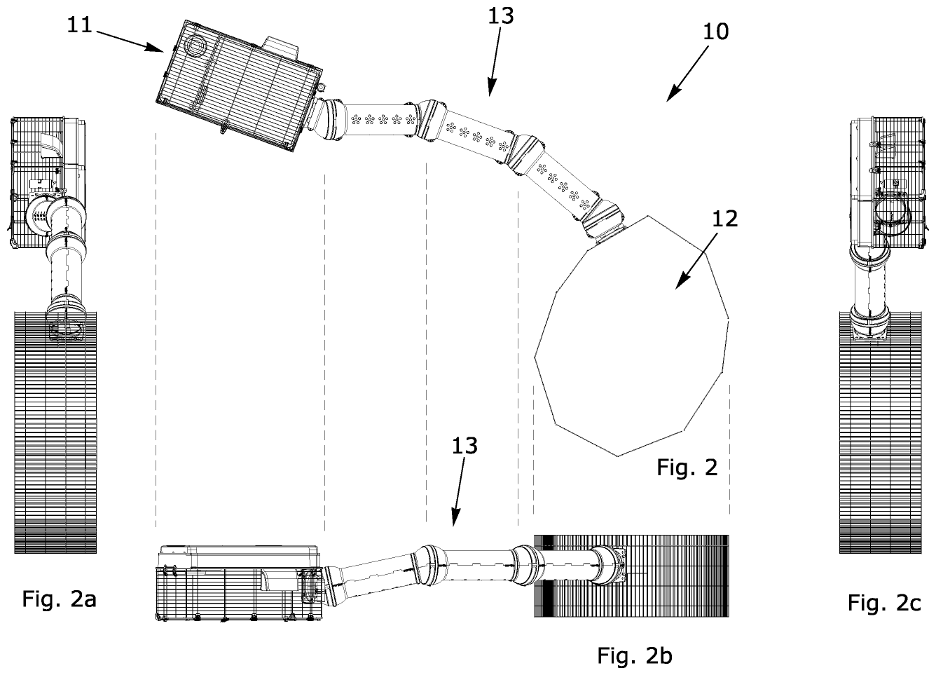

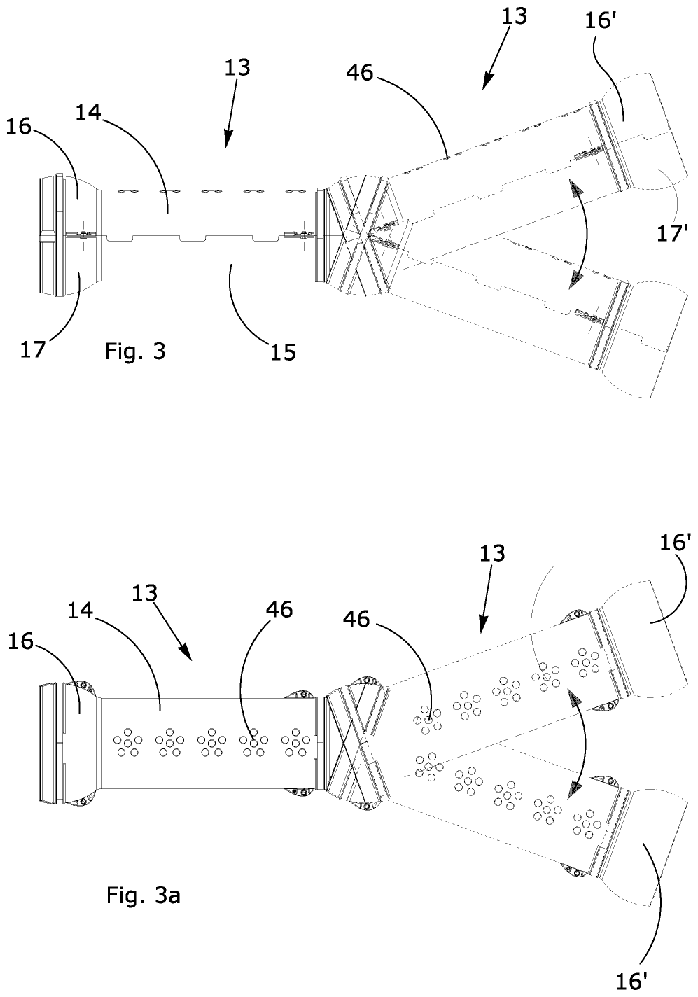

In the illustrated embodiment, such an artificial habitat comprises a series of components including a cage 11, placed at a certain distance to an enclosed area 12 and a plurality of tubular connecting elements 13 which, according to the current production standards, allow to create customizable, modular paths of various lengths, which can be connected to the respective cages both to obtain paths that start and end in the same cage, or that connect different cages, or that create paths between the interior of the cage and the exterior, typically to reach a grassy enclosed fenced area on which to nibble, as in the example illustrated in FIGS. 1 and 2.

According to the embodiment depicted in the same FIGS. 1 and 2, the tubular connecting elements 13, which depict as mentioned the connection means between two areas spaced apart from each other, i.e., between the cage 11 and the enclosed area 12, are depicted by tubular elements comprising means for the reciprocal connection thereof and articulation thereof.

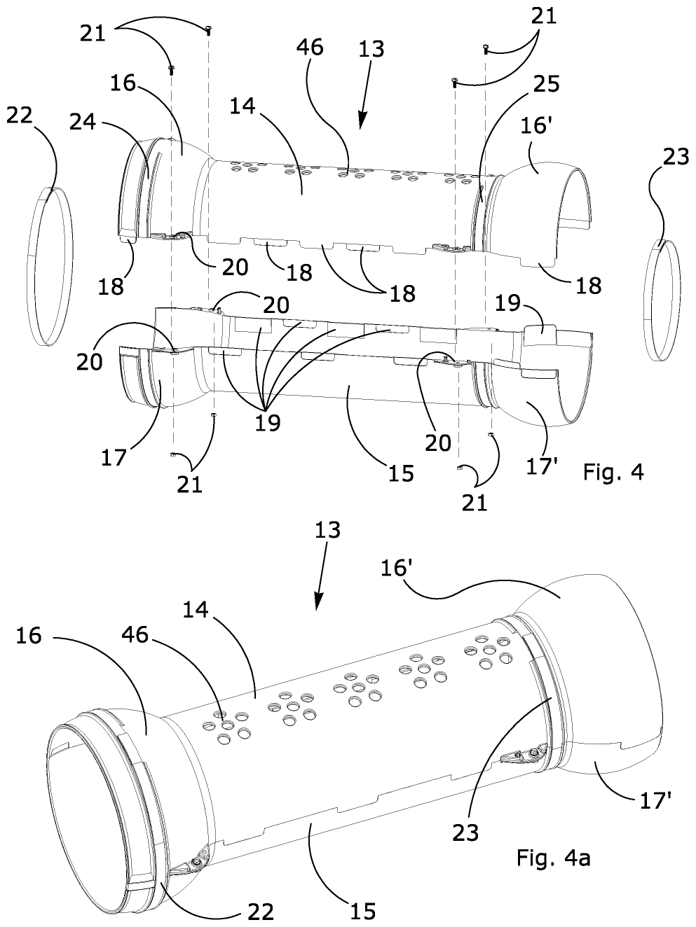

More in particular, with reference to FIGS. 3, 3a and in more detail in FIGS. 4 and 4a, related to a first embodiment, the connecting element 13 has a tubular body formed by two half-parts 14 and 15 obtained by sectioning the tubular body along a plane which contains the longitudinal axis of the tubular body itself.

The two half-parts are joined to each other by suitable fixing means, as will be better described in the following.

At the two ends of the tubular body formed by the two half-parts 14 and 15 a spherical cap portion is included which is obtained from joining two half-parts 16 and 17, which forms a first half of a spherical joint and a further spherical cap portion, obtained from joining two half-parts 16′ and 17′, which forms a second half of a spherical joint.

More in particular, according to the embodiment depicted in FIGS. 3, 3a and 4, 4a, the spherical cap portion obtained from joining two half-parts 16 and 17, which forms the said first half of a spherical joint, has a slightly greater diameter than the diameter of the spherical cap portion obtained from joining the two half-parts 16′ and 17′, which forms the said second half of a spherical joint.

Thereby when two identical tubular connecting elements 13 are connected to each other, the end obtained from joining the two half-parts 16′ and 17′ (male) of the smaller diameter spherical cap of a first connecting element is inserted inside the other end obtained from joining the two half-parts 16 and 17 (female) of the larger diameter spherical cap of a second connecting element, a spherical joint is formed that allows the rotation of a tubular connecting element with respect to another adjacent connected tubular connecting element.

Furthermore, the end section of the female spherical cap obtained from joining the two half-parts 16 and 17 must have a smaller diameter with respect to the diameter of the male spherical cap obtained from joining the two half-parts 16′ and 17′, so as to prevent the male spherical cap from being able to detach from the female spherical cap once two elements have been assembled together.

The two half-parts 14 and 15, whose joining forms the central sleeve portion together with the two half-parts 16, 17 and 16′, 17′ with spherical caps, externally have reciprocal coupling means represented by protruding tabs 18 of one part that face respective recesses 19 of the other part, as well as projections 20 provided with holes that are traversable by screw joining elements 21 or other type, in order to allow the reciprocal locking between one half part and the other.

Further connecting and retaining elements between one half-part and the other are represented by bands 22 and 23, for example of the narrowing type, that are insertable into respective annular grooves 24 and 25.

From an operational point of view, the two half-parts that make up the tubular connecting element 13 are joinable to form a single body simply by approaching the two edges of the longitudinal sections that are coupled by interlocking and fixing them in this position by means of the use of screws 21 and bands 22 and 23.

It should be noted that the joining operation is carried out by simultaneously joining a plurality of tubular connecting elements 13, ensuring that the two male spherical cap half-parts 16′ and 17′ enter the internal seat of the two female spherical cap half-parts 16 and 17 of the adjacent tubular element.

Summarizing, the tubular connecting element according to the invention must be made in such a way that the diameters of the two spherical caps obtained from joining the two pairs of half-parts 16, 17 and 16′, 17′ placed at the ends of a tube, are different from each other.

It is further necessary that the dimensions of the spherical caps are such that one can rotate within the other for a given solid angle.

According to a preferred embodiment of the invention, the diameter of the end section of one spherical cap is smaller than the diameter of the other spherical cap to prevent the two parts of the articulation from being detached from each other when two connecting elements are connected to each other.

By way of example, the solution depicted in the figures allows the angular movement between one tubular element and the adjacent one with a solid angle of 40°, which offers an important degree of freedom between one tubular element and the other.

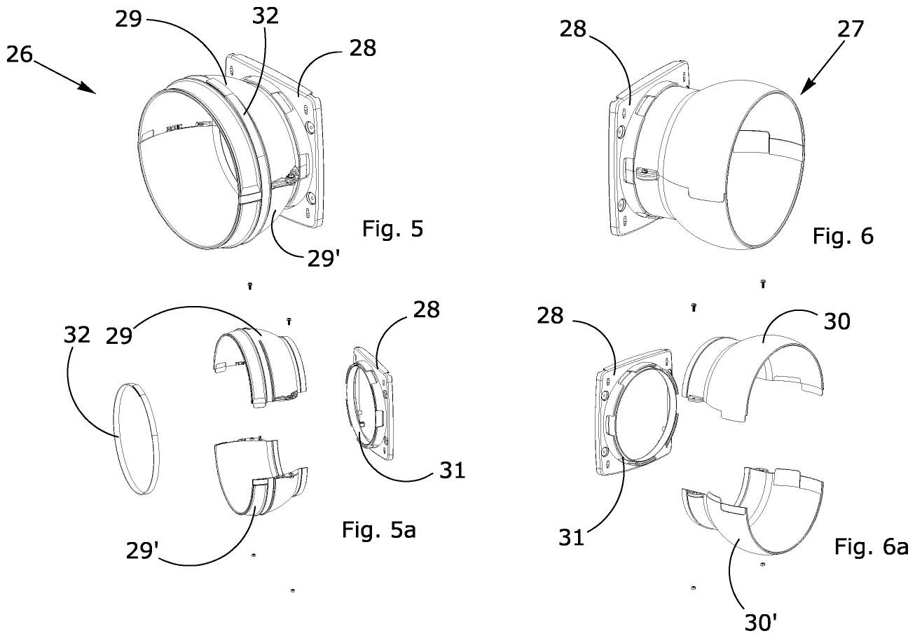

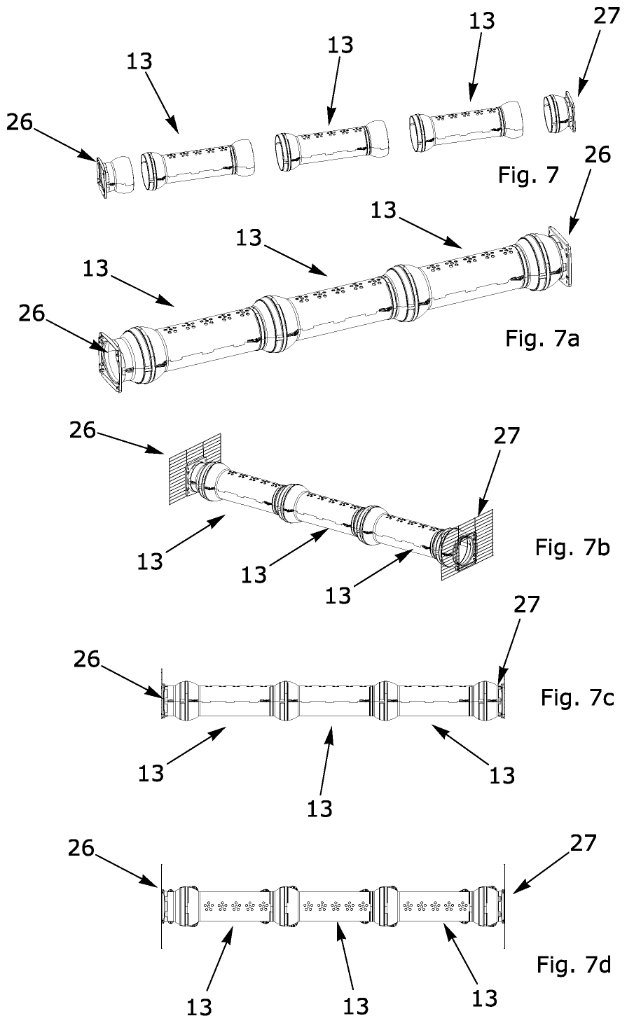

According to the embodiment depicted in FIGS. 5, 5a, 6 and 6a, it is envisaged to use a female 26 and male 27 connecting component provided with a connecting plate 28 adapted to be hooked to an opening made on a cage for containing animals such as rodents or the like.

Also in this case, the connecting components 26 and 27 are formed by two female 29 and 29′ and male 30, 30′ spherical half-parts, of which the first has larger dimensions with respect to the second so as to couple the respective male or female parts of the tubular connecting element 13 to which they hook.

The connecting plate 28 is provided with a flange 31 that is couplable with respective interlocking edges of the female 29 and 29′ and male 30, 30′ spherical half-parts forming the connecting components 26 and 27.

The connecting components 26 and 27 are affected by the presence of band or screw clamping elements 32, similar to the fixing means for the tubular elements described above.

Normally rabbit cages have a plastic bottom raised from the ground by about 15-20 cm, for which it is envisaged that the connecting plates 28 can be positioned on an opening of the cage placed above the edge of the plastic bottom, whereby hooking the tubular elements 13 to the connecting components 26 and 27 it is possible for them to rest directly on the ground, also making all subsequent connections with other tubular elements that can rest on the ground possible, without using any specific accessory, such as the traditional “S” curves, the inclined connections, regardless of the height of the plastic base.

Furthermore, the constructive form of the tubular elements according to the invention makes it possible to use a single support point at the half-parts 16, 17 and 16′, 17′ that form the articulated joint, thus maintaining a certain distance of the tube from the ground and solving the problem of contact with the grass of the garden.

It can be seen that the two half-parts of each tubular element can be stacked on top of each other, and kept together also using a hook obtained directly on the piece, making the item ready for sale and with particularly low transport volumes.

Furthermore, it is envisaged that the connection between the two half-parts can occur in many ways, for example using plastic hooks obtained directly on the tube itself, bolts, specific pawls, elastic bands, or other.

It should also be noted that the locking system of the female spherical portion that firmly and safely embraces the male sphere allowing the rotation thereof, prevents one from detaching from the other even if subjected to pressure, traction, thrust or stress in general of the item when in use.

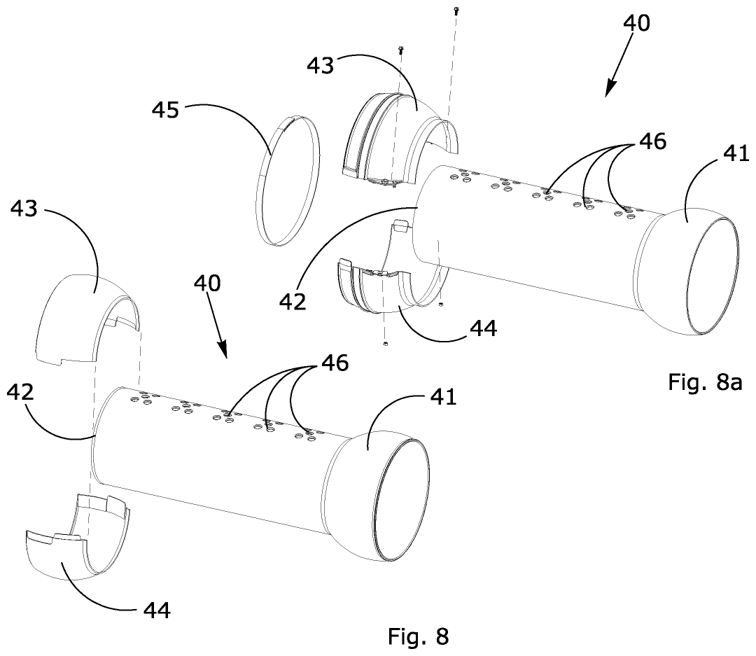

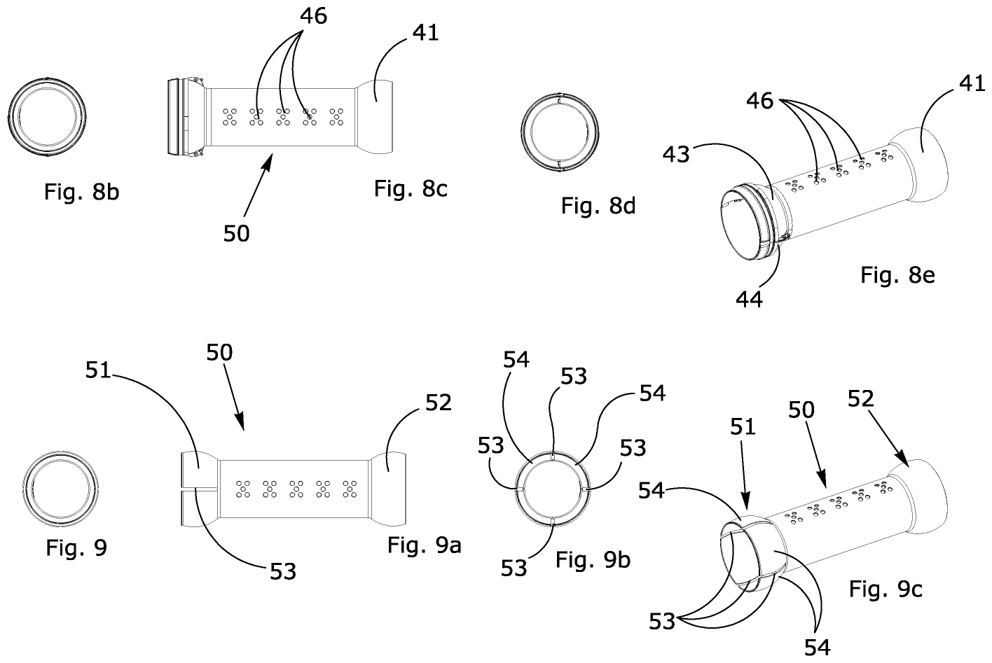

According to the embodiment depicted in FIGS. 8 to 8e, it is also possible to make ventilation holes 46 along the entire upper and/or lower section of the tubular elements 13, where the surface can be smooth (easy to clean but less resistant) or corrugated (difficult to clean but more resistant), with thin or increased thicknesses, depending on the size and intended use.

According to an embodiment depicted in FIGS. 8 to 8e, the tubular element 40 is made in a single piece with the male spherical cap 41, and in this case the end of the tubular element 42 opposite the male spherical cap 41, is provided with a groove on which two spherical half-parts 43 and 44 are to be hooked, connectable and fixable on the tubular element by means of joining systems similar to those described above, including an interlocking joining system, depicted in FIG. 8, a traction band 45, and/or screwing means or the like, as depicted in FIG. 8a.

According to a further embodiment depicted in FIGS. 9 to 9c, it is also envisaged to make a tubular connecting element 50 comprising two spherical caps 51 and 52 placed at the two ends, of which the cap 51 is female and the other 52 is male. According to such a solution, at least one of the two caps, preferably the female cap 51, is made with notches 53 obtained along planes parallel to the longitudinal axis of the cap, so as to obtain flexible tabs 54 for an elastic interlocking connection with the cap of the adjacent tubular connecting cap.

Also in this case the female cap 51 is configured to comprise the male cap 52 with an elastic connection obtained with the flexible tabs 54, where the diameters of the two spherical caps placed at the ends of a tube are different from each other.

Furthermore, also in this case, it is necessary that the dimensions of the spherical caps are such that one can rotate inside the other for a certain solid angle.

Similar to the previous solutions, the diameter of the end section of one spherical cap is smaller than the diameter of the other spherical cap to prevent the two parts of the articulation from detaching from each other when two connecting elements are connected to each other, simultaneously allowing the rotation of one tubular element with respect to the other, according to predetermined angles.

Further accessories are also envisaged such as intermediate stations to create specific spaces, such as 90° curves, “T” connecting points that represent a shelter for the rabbit, a water and food container, or other.

Furthermore, the tubular elements can be made entirely in solid or entirely transparent colour, or with areas of transparency alternated with opaque areas, so as to be able to see the animal inside.

The invention has been described in the foregoing with reference to a preferential embodiment thereof. However, it is envisaged that the invention is susceptible to some variants which fall within the scope thereof, and which are technically equivalent.

1. A tubular connecting element adapted to be joined to further consecutive tubular connecting elements to form one or more connections between cages and enclosed spaces that can be walked through by household pets, the tubular connecting element comprising:
a tubular body having a first end and a second end opposed to each other, wherein the first end of the tubular body is provided with a first spherical cap portion that forms a first half of a spherical joint, and the second end of the tubular body is provided with a second spherical cap portion that forms a second half of a spherical joint, wherein the first half of the spherical joint has a first predetermined diameter which is greater than a second predetermined diameter of the second half of spherical joint so as to define, respectively, a first female half of the spherical joint and a second male half of the spherical joint, which are opposed to each other when two tubular connecting elements are joined to each other by their respective ends, and wherein an end section of the first female half of the spherical joint has a smaller diameter with respect to the diameter of the corresponding portion of the second male half of the spherical joint, so as to prevent the second male half of the spherical joint from being able to slip out of the first female half of the spherical joint when the second male half of the spherical joint is inserted inside the first female half of the spherical joint.

2. The tubular connecting element of claim 1, wherein when two identical tubular connecting elements are connected to one another, the second male half of the spherical joint of a lesser diameter of a first tubular connecting element is inserted inside the first female half of the spherical joint of greater diameter of a second tubular connecting element, a spherical joint is formed that is configured to allow an angular reciprocal rotation between the first and the second tubular connecting elements.

3. A The tubular connecting element of claim 1, wherein the dimensions of the first and second spherical cap portions are such that one can rotate inside the other by a given solid angle.

4. The tubular connecting element of claim 1, wherein the tubular connecting element is formed by a conjunction between two half-parts obtained by sectioning the tubular body along a plane that contains the longitudinal axis of the tubular body.

5. The tubular connecting element of claim 4, wherein the two half-parts, the joining of which forms the tubular body to which are associated the first and the second cap portions, comprise, at the joining edges thereof, reciprocal coupling and fixing elements.

6. The tubular connecting element of claim 5, wherein the reciprocal coupling and fixing elements placed at the joining edges comprises protruding tabs that face respective recesses, as well as further projections provided with holes that are crossed by joining elements, configured for mutual retention between one half-part and the other half-part of the two half-parts.

7. A The tubular connecting element of claim 5, wherein the reciprocal coupling and fixing elements between the two half-parts, comprise bands that are configured to be inserted into respective annular grooves provided between the tubular body and the respective first and second spherical cap portions.

8. The tubular connecting element of claim 1, wherein at least one of the first female half of the spherical joint or the second male half of the spherical joint is provided with a connecting plate, configured to be connected to an opening made in a cage or in an enclosure.

9. The tubular connecting element of claim 8, wherein the connecting plate is provided with a flange that is joined to respective interlocking edges of the at least one of the first female half of the spherical joint or the second male half of the spherical joint.

10. The tubular connecting element of claim 1, wherein at least one of the first and second spherical cap portions comprises notches configured to realize flexible tabs forming an elastic interlocking connection between two adjacent spherical cap portions.
